(19) United States
(12) Patent Application Publication
(10) Pub. No.: US 2017/0330132 A1
(43) Pub. Date: Nov. 16, 2017

(54) METHOD AND SYSTEM TO MANAGE SUPERVISION ACTIVITY IN UTILITY SYSTEM TO REDUCE DAMAGE

(71) Applicant: International Business Machines Corporation, Armonk, NY (US)

(72) Inventors: JAYANT KALAGNANAM, Tarrytown, NY (US); Dung Phan, Ossining, NY (US); Yada Zhu, Irvington, NY (US)

(21) Appl. No.: 15/154,208

(22) Filed: May 13, 2016

(51) Int. Cl. G06Q 10/06; G06Q 10/00; G06N 99/00; G06F 17/50; G06N 7/00; G06Q 50/08

(52) U.S. Cl. CPC G06Q 10/063116; G06Q 50/08; G06Q 10/20; G06Q 10/06313; G06F 17/5009; G06N 7/005; G06N 99/005; G06F 2217/16

(57) ABSTRACT

A method comprises obtaining, at a data correction module, at least one input indicative of a planned digging activity, the planned digging activity occurring within a prescribed period of time, the at least one input comprising information relating to the planned digging activity; generating, using the data correction module, a correction of the input of the planned digging activity; generating, using a predictive modeling module, an outage probability of a utility as a function of the corrected input of the planned digging activity event and predictive data based on a predictive modeling technique; generating, using a scheduling optimization algorithm, an optimal schedule as a function of a travel cost and the outage probability of the utility; and initiating a response based on the optimal schedule to mitigate an occurrence of a power outage predicted to result from the planned digging activity.

### BACKGROUND

The exemplary embodiments of this invention relate generally to management of utility systems and, more specifically, to methods, systems, and apparatuses to manage supervisory crew members to reduce human-induced damage to utility systems.

Construction activity is often a driving factor in the cause of damage to utility systems that results in power outages, disruptions in water supply or wastewater removal, and/or communication. For example, errors made by humans in the course of various road work projects or excavation activities associated with the construction and maintenance of underground infrastructure (e.g., underground power lines, gas lines, water pipes, telecommunication cables, etc.) can cause damage to existing lines, pipes, or cables, either resulting in an immediate outage or contributing to a subsequent outage (e.g., an outage occurring days, weeks, or months after a damage incident) or otherwise resulting in a disruption in some type of service. Each year this type of human error can create safety issues and incur significant financial loss.

One conventional approach to mitigating power outages or service disruptions involves the use of public safety programs that encourage inquiries regarding the location of underground lines or pipes before any digging occurs. Such programs are often referred to as “call before you dig” programs in which any planned construction that involves below grade work is reviewed by a relevant authority in order to determine whether such construction poses a risk to public or worker safety.

Another approach involves the manual and subjective task of ranking individuals based on past occurrences of causing outages or disruptions to thereby predict the risk of an outage or disruption in a current project. This method, however, ignores the impact of other associated human-related factors that contribute to the outages or disruption from digging damage, such as activity type, activity location, etc. Additionally, other challenges involve the management of limited resources, such as crew and budget allocation, under various uncertainties to reduce the risk of outages.

### BRIEF SUMMARY

In one exemplary aspect, a method comprises obtaining, at a data correction module, at least one input indicative of a planned digging activity, the planned digging activity occurring within a prescribed period of time, the at least one input comprising information relating to the planned digging activity; generating, using the data correction module, a correction of the input of the planned digging activity; generating, using a predictive modeling module, an outage probability of a utility as a function of the corrected input of the planned digging activity event and predictive data based on a predictive modeling technique; generating, using a scheduling optimization algorithm, an optimal schedule as a function of a travel cost and the outage probability of the utility; and initiating a response based on the optimal schedule to mitigate an occurrence of a power outage predicted to result from the planned digging activity.

In another exemplary aspect, a method for reducing an occurrence of power outage caused by a planned digging activity comprises receiving, at a data correction module, a first set of data relating to a notification indicative of a digging activity; updating the received first set of data to include a second set of data relating to the notification indicative of a digging activity; predicting a risk factor, based on the updated first set of data and the included second set of data, using a set of trained models and parameter priors to define a risk ranking; optimizing a schedule for a human supervisor to visit the digging activity, the optimized schedule being a function of a travel cost and the risk ranking; and using the schedule to cause the human supervisor to visit the digging activity based on the optimized schedule, the response being a function of the risk ranking.

In another exemplary aspect, a computer program product for reducing an occurrence of power outage caused by a planned digging activity comprises a computer readable storage medium having program instructions embodied therewith, the program instructions being executable by a computer to cause the computer to: receive, at a data correction module, a first set of data relating to a notification indicative of a digging activity; update the received first set of data to include a second set of data relating to the notification indicative of a digging activity; predict a risk factor, based on the updated first set of data and the included second set of data, using a set of trained models and parameter priors to define a risk ranking; and optimize a schedule for a human supervisor to visit the digging activity, the optimized schedule being a function of a travel cost and the risk ranking.

### BRIEF DESCRIPTION OF THE SEVERAL VIEWS OF THE DRAWINGS

The foregoing and other aspects of exemplary embodiments are made more evident in the following Detailed Description, when read in conjunction with the attached Drawing Figures, wherein:

FIG. 1 is a block diagram of one exemplary embodiment of a system for managing supervision activity in a utility system;

FIG. 2 is a block diagram of one exemplary embodiment of a schedule optimizer for use in the system of FIG. 1;

FIG. 3 is a graphical representation of a number of digging events as a function of date;

FIG. 4 is a conceptual representation of results generated by the schedule optimizer; and

FIG. 5 is a block diagram of one exemplary embodiment of exemplary electronic devices that are suitable for use in the system of FIG. 1.

### DETAILED DESCRIPTION

Exemplary embodiments of methods, systems, and apparatuses pertaining to industry solutions for the management of utilities such as energy, power, and communication networks are disclosed herein. Such methods, systems, and apparatuses are based on novel analytics that use notifications and various data sources to optimize supervisory crew deployment to reduce the likelihood of power outages or other service disruptions caused by digging or similar excavation activities. Using the methods, systems, and apparatuses disclosed herein, supervisor visits can be automatically allocated to jobsites to reduce the number of power outages or other service disruptions with minimal logistics cost. The novel analytics described herein include, but are not limited to, combined predictive analysis and constrained optimization techniques to provide tools that optimally dispatch construction supervisors to worksites, propose optimization models, and propose mathematical algorithms to obtain solutions to the optimization models. However, it should be understood that the disclosed analytics are merely illustrative of the claimed methods and systems, which may be embodied in various forms. Furthermore, it should be understood that although the disclosure herein refers to outages due to “digging” or “excavation” as it pertains to electricity distribution systems, the embodiments described are also applicable to any type of disruption due to construction (or destruction) activity as it pertains to gas distribution, water and wastewater systems, and communications networks.

Power outages due to digging damage are generally not random. Digging damage may be correlated to various factors, such as for example digging depth, distance between work sites and lines, cables, and other systems, activity type (e.g., construction, vegetation placement, placement of objectives, etc.), soil type and moisture levels, cable type or cable joint type, previous damage, and the like. Incomplete and/or inaccurate information (e.g., wrong or missing measurements, lack of work history, unknown system locations) can further cause challenges to the development of analytics to provide accurate predictions. Additionally, challenges for the opportunity for optimal response to predicted digging damage can result from insufficient notice of a digging operation (e.g., notice is provided one day or one month before digging is scheduled to begin, possibly due to weather), lack of notice altogether (e.g., due to inability to provide notice), inability of an authority such as an electrical power company to authorize or provide changes to proposed digging plans, and estimation of the impact of assigning supervisory units.

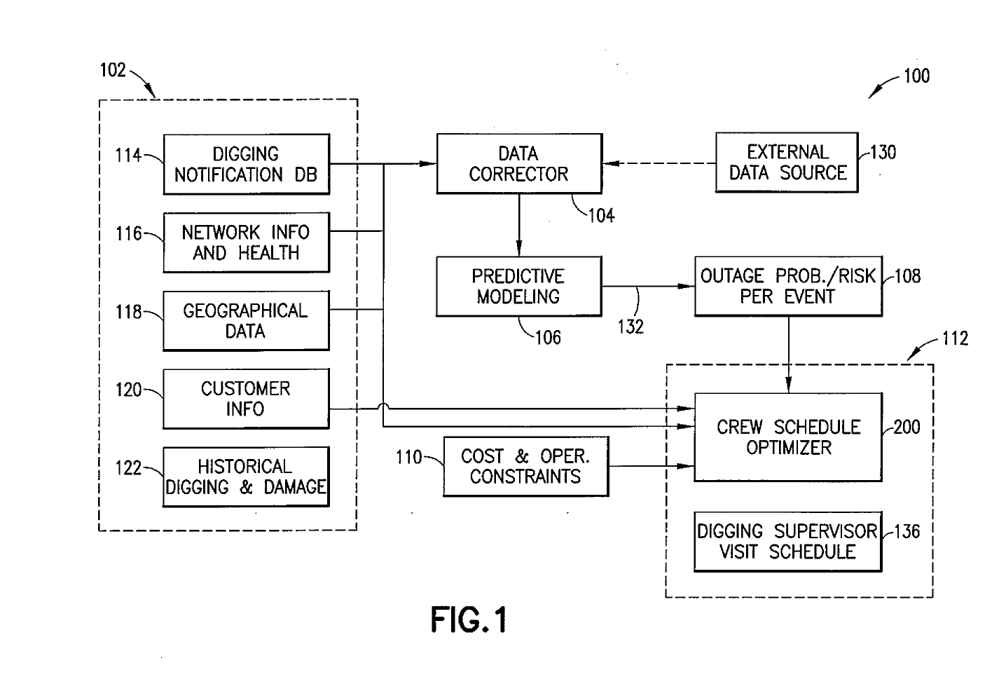

Referring to FIG. 1, one exemplary embodiment of a system for managing supervision activity in utility systems is designated generally by the reference number 100 and is referred to hereinafter as “system 100.” System 100 comprises a memory module 102, a data correction module 104, a predictive modeling module 106, an output module 108, a cost database 110, and a scheduling module 112. Output from one or more databases of the memory module 102, the output module 108, and the cost database 110 is received at the scheduling module 112. At least a portion of the input from the memory module 102 comprises vector-based data indicative of biographical, geographical, and/or historical characteristics of diggers, infrastructure, and customers associated with the utility systems, such data being manipulated by the data correction module 104 and processed through the predictive modeling module 106.

The memory module 102 is organized into one or more databases comprising a digging notification database 114, a network information and health database 116, a geographical data database 118, a customer information database 120, and a historical digging and damage database 122. Other information may also be stored for further processing in accordance with exemplary embodiments. Other databases may also be included.

The digging notification database 114 stores data pertaining to digging notifications such as information relating to planned digging activities by, for example, construction and excavation companies, power companies, water companies, gas companies, and telecommunications providers. The planned digging activities can be reported within any suitable time frame relative to the digging activity (e.g., on the same day as the proposed digging activity or several months in advance of the proposed digging activity or even longer).

The network information and health database 116 stores comprehensive information relative to the power grid such as, for example, system topology, failure and repair history, component information (e.g., cable type or cable joint type), dates of installation and maintenance history of equipment, voltage level information, manufacturer information (e.g., serial numbers, model numbers, equipment sources), and the like.

The geographical data database 118 stores comprehensive geographical information related to power grids, customers, and town and ZIP code data, such as latitude and longitude coordinates of each customer and grid component, as well as connection data pertaining to each customer and grid component. Other geographical information, such as elevation data, contour maps, proximity to water, and water depth may also be stored.

The customer information database 120 stores customer geographical data, customer type (e.g., residential, commercial, industrial, school, hospital, or other. type), usage patterns, meter location and identification, power outage history, theft history, and the like.

The historical digging and damage database 122 stores information regarding the histories of power outages due to digging damage, such as, for example, particular digging contractors, digging activities that caused the power outages, time and location of the damage, which digging notification resulted in the power outage, outage duration, repair actions, repair contractors, and the like.

At least a subset of the information stored in the memory module 102 is supplied to the data correction module 104 as inputs thereto. In system 100, the data correction module 104 is configured to receive information from the digging notification database 114, the network information and health database 116, and the geographical data database 118. The present embodiments as disclosed herein are not so limited, however, as various other combinations of information received by the data correction module 104 are similarly contemplated, including information not necessarily stored in the memory module 102, but rather received from an external data source 130 (e.g. flash drive or the like). The received digging notifications, network information, and other data sources may contain incomplete and/or inaccurate information. For example, digging depth may be a missing parameter from the digging notification information, and thus the distance to an underground power cable may not be accurately estimated based on the location of digging activities alone. The data correction module 104, according to one or more embodiments, is configured to correct an aspect of the input data using a combined clustering, association, and statistical modeling method in order to update and/or incorporate additional data with the input data to improve data quality.

An output of the data correction module 104, which may be referred to herein as a corrected digging notification, is supplied to the predictive modeling module 106. The predictive modeling module 106, in one or more embodiments, is operative to generate one or more outputs relating to a risk factor such as an outage probability or other risk. More particularly, the predictive modeling module 106 is configured to use a set of trained models and parameter priors to receive, as an input thereof, outputs of the data correction module 104 and to predict risk ranking based on one or more of various aspects indicative of risk, such as prescribed activity factors (e.g., digger, activity types, etc.), outage probability/risk of individual events, and zonal outage probability/risk. For example, in the embodiment shown in FIG. 1, the predictive modeling module 106 is configured to generate an output 132 corresponding to an outage probability/risk per event at the output module 108. One exemplary embodiment of a trained model or predictive modeling technique utilized by the predictive modeling module 106 to derive the output 132 can be, for example, any algorithm which can express a dependent variable as a linear combination of other features or measurements (e.g., a logistic regression model, a Bayesian logistic regression model, a linear discriminant analysis (LDA) model, or the like).

The scheduling module 112 receives input from the memory module 102, the output module 108, and the cost database 110. In the scheduling module 112, a crew schedule optimizer 200 is configured to receive the outage probability/risk for each event generated by the predictive modeling module 106, and may receive at least a subset of other information stored in the memory 102, such as, for example, network information and health data stored in the network information and health database 116, geographical information stored in the geographical data database 118, and customer information stored in the customer information database 120, as well as cost and operational constraint information, which may be stored in the cost database 110. The cost database 110 may store other information such as, for example, labor cost per hour, cost per damage event, upper limit of risk cost of power outage, constraint of type of digging supervisor, available labor hours, etc.

Using the information supplied to the crew schedule optimizer 200 (e.g., the outage probability/risk for each event generated by the predictive modeling module 106), the crew schedule optimizer 200 is preferably operative to generate an optimization model indicative of an outage probability and to initiate an appropriate response as a function of the outage probability/risk. For example, in this exemplary embodiment, the crew schedule optimizer 200 is operative to initiate one or more digging supervisor visit schedules 136 as a function of the outage probability/risk for each event and to generate an optimal visit schedule for digging supervisors. In other words, the crew schedule optimizer 200 is configured to optimally select a schedule for digging supervisors to visit job sites by minimizing travel costs and outage costs. The optimally selected schedule is subject to limited numbers of supervisory crews and work crews to be supervised, histories of adherence to work schedules, histories of supervisory crews arriving at job sites before work crews, and service time duration. An illustrative operation of the crew schedule optimizer 200, according to one or more embodiments, is described further below.

In the operation of the crew schedule optimizer 200, data from the memory module 102 is received in the data correction module 104, processed, and sent to the predictive modeling module 106. Predictive modeling, as may be performed for example in the predictive modeling module 106, may be expressed by the logistic function:

$$p ( x ) = \frac{exp ( {β}^{T} x )}{1 + exp ( {β}^{T} x )} = \frac{1}{exp ( - {β}^{T} x ) + 1} \qquad ( Eq . 1 )$$

where the inputs x are multiple predicting variables, e.g., distance, depth, activity type, and diggers; β are the coefficients to be estimated; and the output p(x) is confined between 0 and 1 and is interpretable as a probability of the dependent variable equaling a “success” (e.g., greater than 0.5 (the threshold value)) rather than a “failure” (e.g., less than 0.5) (in other words, the output p(x) represents the probability that an outage event can happen). With regard to β, a large β^{T}x results in a large value of p(x), i.e., a large probability of power outage. Therefore the value of β associated with each digger reflects its risk of inducing digging damage. Accordingly, each digger can be ranked based on β^{T}x values. The digger risk ranking shows the risk rank of a number of diggings based on corresponding β^{T}x values. Threshold values can be selected to rank these diggers into different ranks. With regard to the probabilities, the probability values are reduced if the digging sites are visited. The probability values may then operate as inputs for crew visit scheduling.

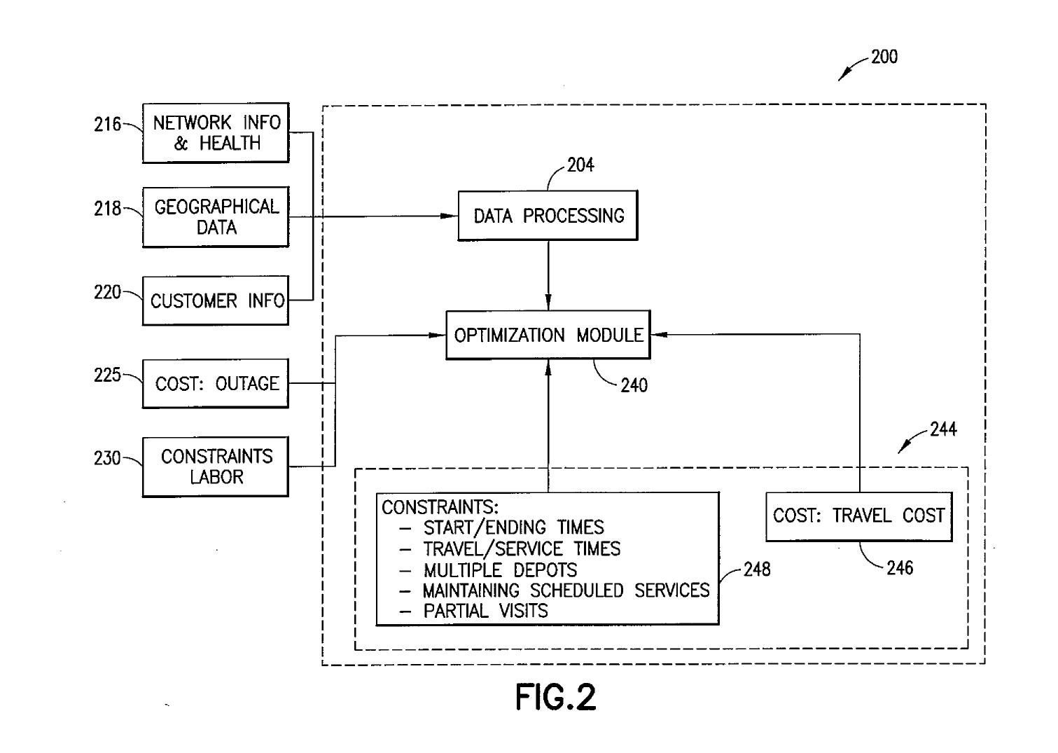

Referring now to FIG. 2, one exemplary embodiment of the crew schedule optimizer 200 suitable for use with the system 100 is illustrated. This configuration, which may be used in the implementation of the scheduling module 112 in FIG. 1, comprises a data processing module 204 adapted to receive prescribed information, such as, but not limited to, information from a network information and health database 216, a geographical information database 218, and a customer information database 220, each of which may represent a corresponding database in the memory 102 shown in FIG. 1. The data processing module 204, which may correspond to the data correction module 104 and the predictive modeling module 106, is configured to cluster digging events as a function of the information received from one or more of the respective databases 216, 218, and 220. The data processing module 204 may be further configured to receive information pertaining to outage costs 225 as well as labor constraints 230.

The crew schedule optimizer 200 includes an optimization module 240 that schedules crew visits. The optimization module 240 receives information pertaining to the clustered digging events from the data processing module 204 and further receives information from a travel cost processing module 244 configured to estimate the cost for digging supervisors to travel to various jobsites. Estimation of the cost for travel may be obtained from direct travel costs 246 using simulation or any suitable alternative estimation methodology. Travel-related constraints 248 associated with the travel cost processing module 244 include, but are not limited to, the number of available supervisors, travel distance, start/end times of jobs, times of travel and/or service, whether or not travel is between multiple depots, coordination of schedules between depots, maintenance of scheduled services, whether or not partial visits to jobsites are desired, and the like. The optimization module 240 is configured to generate an output (e.g., supervisor visit schedule 136) as a function of the direct travel costs 246 and labor constraints 248 and information from the data processing module 204. When only one digging supervisor is needed per digging event and no start and end times are considered, this output may be expressed as:

$$Min {\sum }_{n = 1}^{N} {x}_{n} {h}_{n} {C}_{h} + {\sum }_{n = 1}^{N} {x}_{n} {q}_{n} {C}_{n} + {\sum }_{n = 1}^{N} ( 1 - {x}_{n} ) {p}_{n} {C}_{n} \\ s . t . {\sum }_{n = 1}^{N} {x}_{n} {q}_{n} {C}_{n} + {\sum }_{n = 1}^{N} ( 1 - {x}_{n} ) {p}_{n} {C}_{n} \leq C \\ {\sum }_{n = 1}^{N} {x}_{n} {h}_{n} \leq {\sum }_{k = 1}^{K} {H}_{k} \\ {q}_{n} = {r}_{n} {p}_{n} \\ 0 \leq {r}_{n} \leq 1 \qquad ( Eq . 2 )$$

where N represents the total number of digging events, pₙ represents outage probability of the n^{th} digging event, n=1, . . . , N, qₙ represents outage probability of the n^{th} event if a digging supervisor is assigned to monitor the event, n=1, . . . , N, Cₙ represents outage cost of the n^{th} digging event, C represents an upper limit of total cost induced by a power outage, xₙ: (0,1), xₙ=1 (visit), xₙ=0 (no visit), hₙ represents the required number of labor hours for visiting the n^{th} event, Cₕ represents the unit cost per labor hour, K represents the total number of available digging supervisors, and Hₖ represents available labor hours of the k^{th} digging supervisor.

In the exemplary embodiments as described herein, however, when the generated output further accounts for a travel cost and the travel-related constraints from the travel cost processing module 244, the output as the total cost to be minimized may be a function of both the travel cost and the outage cost and may be a crew visit schedule model expressed using the algorithm:

$${min}_{{x}_{i , j}^{n} ∈ \{ 0 , 1 \}} {\sum }_{( i , j ) ∈ 𝒜 , n ∈ 𝒟} {c}_{i , j} {x}_{i , j}^{n} + β {\sum }_{j ∈ 𝒯} ( {\sum }_{i ∈ {𝒩}_{j} , n ∈ 𝒟} {x}_{i , j}^{n} {q}_{j} {c}_{j}^{out} + ( 1 - {\sum }_{i ∈ {𝒩}_{j} , n ∈ 𝒟} {x}_{i , j}^{n} ) {p}_{j} {c}_{j}^{out} ) \qquad ( Eq . 3 )$$

The constraints of Equation 3 are embodied in Equations 4-17, as noted below. Each node i satisfies a worker balance flow constraint for every depot n:

$${\sum }_{j ∈ {𝒩}_{i}} {x}_{i , j}^{n} = {\sum }_{j ∈ {𝒩}_{i}} {x}_{j , i}^{n} , ∀ i ∈ 𝒩 , n ∈ 𝒟 \qquad ( Eq . 4 )$$

Event j ∈ [symbol] is performed at most once:

$${\sum }_{i ∈ {𝒩}_{j} , n ∈ 𝒟} {x}_{i , j}^{n} \leq 1 , ∀ j ∈ 𝒯 \qquad ( Eq . 5 )$$

Scheduled event j ∈τ₀ has to be visited:

$${\sum }_{i ∈ {𝒩}_{j} , n ∈ 𝒟} {x}_{i , j}^{n} = 1 , ∀ j ∈ {𝒯}_{0} \qquad ( Eq . 6 )$$

No more than ωₙ workers are leaving depot n:

$${\sum }_{j ∈ {𝒩}_{n}} {x}_{i , j}^{n} \leq {ω}_{n} , ∀ n ∈ 𝒟 \qquad ( Eq . 7 )$$

Previous service time plus travel time is less than the next start time:

$${t}_{i} + {s}_{i} + {d}_{i , j} \leq {t}_{j} + M ( 1 - {\sum }_{n ∈ 𝒟} {x}_{i , j}^{n} ) , ∀ ( i , j ) ∈ 𝒜 and j ∈ 𝒯 \qquad ( Eq . 8 )$$

Returning to depot n before the end of working day T:

$$( {\sum }_{i ∈ {𝒩}_{j}} {x}_{i , j}^{n} ) ( {t}_{j} + {s}_{j} + {d}_{j , n} ) \leq T , ∀ j ∈ 𝒯 , n ∈ 𝒟 \qquad ( Eq . 9 )$$

Consistency index for a worker leaving a depot:

x_{i,j}ⁿ=0, ∀i, n ∈ [symbol] , j ∈ [symbol] , and i≠n (Eq. 10)

Consistency index for a worker returning to a depot:

x_{j,i}ⁿ=0, ∀i, n ∈ [symbol] , j ∈ [symbol] , and i≠n (Eq. 11)

When a worker is not allowed to travel from one depot to another:

x_{i,j}ⁿ=0, ∀i, j, n ∈ [symbol] (Eq. 12)

Where there is no self-visit on the graph:

x_{i,i}ⁿ=0, ∀i, ∈ [symbol] , n ∈ [symbol] (Eq. 13)

Here, M is a sufficiently large number representative of the total number (greater than one) of the m^{th} type of digging supervisors, for example:

$$M = {max}_{( i , j ) ∈ 𝒜} \{ {t}_{i} + {s}_{i} + {d}_{i , j} \} ,$$

and it is assumed that tᵢ=sᵢ=0 for every i ∈ [symbol] .

Additional constraints may be added to solve the problem with more efficiency. For example, the inequality relating to the workers leaving depot n may be replaced by the following equality:

$${\sum }_{j ∈ {𝒩}_{n}} {x}_{i , j}^{n} = {ω}_{n} , ∀ n ∈ 𝒟 . \qquad ( Eq . 14 )$$

Restricting the traveling direction on [symbol] based on the arrival time constraint may be:

x_{i,j}ⁿ=0, ∀i, j ∈ [symbol] , n ∈ [symbol] if tᵢ+sᵢ+d_{i,j}>tⱼ (Eq. 15)

x_{i,j}ⁿ=0, ∀i ∈ [symbol] , j ∈ [symbol] , n ∈ [symbol] if tⱼ+sⱼ+d_{j,n}>T. (Eq. 16)

An upper bound on the number of visiting digging events for each worker may be expressed as:

$${\sum }_{j ∈ 𝒯 , i ∈ {𝒩}_{j}} {x}_{i , j}^{n} \leq ⌊ \frac{T - {d}_{min}}{{c}_{min} + {d}_{min}} ⌋ , ∀ n ∈ 𝒟 . \qquad ( Eq . 17 )$$

In the above equations, variables are noted by:
[symbol] Scheduling time horizon;
[symbol] Set of depots,
[symbol] Set of events;
[symbol] ₀ Set of scheduled events;
[symbol] = [symbol] ∪ [symbol] , set of nodes in the undirected graph;
[symbol] ᵢ Set of neighboring nodes of node i;
[symbol] Set of arcs in the graph;
sᵢ Service time for event i ∈ [symbol] ;
tᵢ Start time for event i ∈ [symbol] ;
d_{i,j} Travel time along arc (i, j) ∈ [symbol] ;
c_{i,j} Cost for traveling along arc (i, j) ∈ [symbol] ;
pᵢ Outage probability for event i ∈ [symbol] if not visited;
qᵢ Outage probability for event i ∈ [symbol] if visited;
cᵢ^{out} Outage cost for event i ∈ [symbol] ;
wᵢ Number of workers at depot i ∈ [symbol] ;
x_{i,j}ⁿ=1 if any worker at depot n traveling along arc (i,j) ∈ [symbol] , =0 otherwise.

Although the crew schedule optimizer 200 shown in FIG. 2 is described in terms of separate processing modules and optimization modules configured to perform the stated functions to produce output in the form of a digging supervisor visit schedule, in some exemplary embodiments the functions of the processing and optimization modules may be incorporated into the same module, which may be implemented, for example, using a single processor or controller.

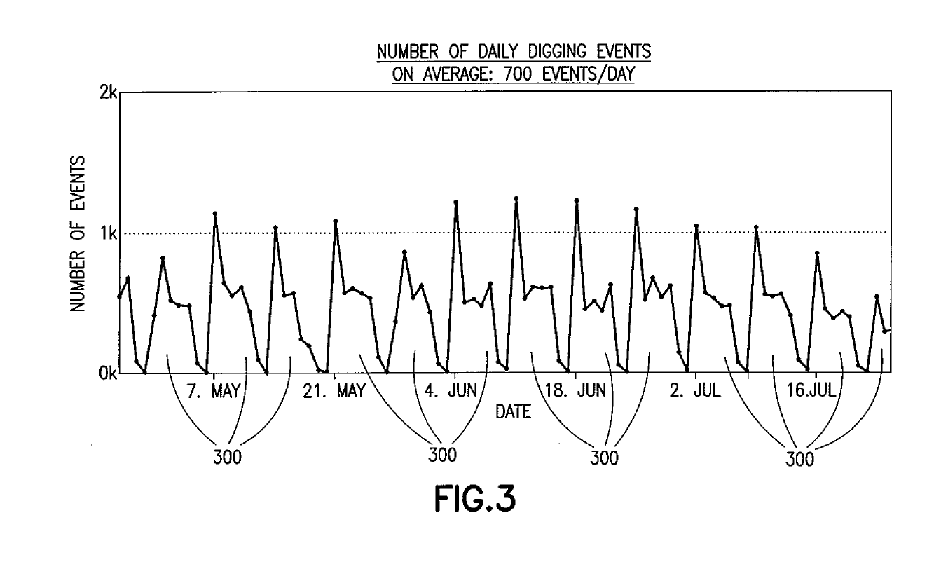

Referring now to FIG. 3, the clustering of digging events as performed by the data processing module 204 of FIG. 2 depicts a number of digging events as a function of date for an illustrative scenario in which various aspects of the disclosed embodiments may be employed. The number of digging events is grouped by date. On average, each day indicates that there can be hundreds of daily digging events (e.g., an average of about 700 events per day, as indicated). For a given planning horizon, such as, for example, one week, or a large geographical area (e.g., Texas), there may be thousands of events to track. In such a scenario, the optimization problem can become too large to solve. Thus, to reduce computational cost, digging events are first clustered, according to one or more embodiments, into disjoint groups 300 based on a set of factors, such as, but not limited to, distance between digging events and required type of supervisors, among other factors. One or more factors, such as, for example, distance, is preferably correlated to one or more other factors, such as, for example, transportation cost for a digging supervisor to monitor multiple digging sites (events). Different digging activities usually require digging supervisors with different knowledge and expertise of the power grid or other infrastructure and equipment. Also, digging events within a group 300 are optimally selected for monitoring, and a work schedule is generated based on the planning horizon.

The clustering of the digging events into groups 300 may be via a k-means algorithm, which is suited by the data processing module 204 for the clustering of the vector-based data such as that from the databases 216, 218, 220, etc. The k-means algorithm also maximizes similarities between points by minimizing total distances between all points from their respective centroids.

The Equations 3-17 are expressed in the following form

$$\begin{matrix}min & {c}^{T} x \\ s . t . & Ax \leq b \\ & x ∈ \{ 0 , 1 \}\end{matrix} \qquad ( Eq . 18 )$$

If it is assumed that x* is a fractional solution of the linear programming relaxation (LP) of Equation (18) by relaxing the integrality restriction, and y is chosen as the nonnegative i^{th} row of B⁻¹, where B is a basis of (A; I) and I is an identity matrix for the slack variables of Equation (18), then the constraint

└y^{T}A┘x≦└y^{T}b┘(Eq. 19)

is a cutting plane. Here └·┘ denotes lower integer part. The cutting plane can prune the fractional vertex x* and tighten the lower bound obtained from the LP relaxation.

Denote S by the set of unexplored nodes in the search tree. For any subproblem s ∈ S, the lower bound can be defined on the optimal value of the s by l(s) computed from its LP relaxation, namely the LPR(s) problem. The best known upper bound is defined by u.

Optimization of the algorithm may be carried out by solving the linear programming relation (LPR) of the Equations 3-17 by a dual simplex algorithm to compute a lower bound. A heuristic approach may be used to possibly update u together with a feasible integer point x. In particular, the algorithm is optimized using the following steps:

Initialize S={Problem(3-17)}, and let u=+∞ if the heuristics fails to find a feasible point.
(a) If S=φ, then the algorithm is terminated.
(b) Select s ∈ S such that l(s)=min{l(t):t ∈ S}.
(c) If LPR(s) has an optimal integral solution, then update u=min{u,l(s)} and x. Set S=S\{c} and return to step (a).
(d) Add cutting planes (19) to the LPR and solve to update l (s). If the LPR is infeasible, set l(s)=+∞.
(e) Select the most fractional variable of LPR(s), e.g., xᵢ^{LPR}. Branch s into two subproblems s⁰ and s¹ by restricting xᵢ=0 and xᵢ=1, respectively.
(f) Compute l(sⁱ), i=1,2. If the LPR is infeasible, set l(s^{t})=+∞. If desired, find feasible integer solutions from sⁱ.
(g) Set S={t ∈ S ∪ {s⁰, s¹}: l(t)<u, t≠s}. Return to step (a).

Solving of the optimization of the algorithm to obtain the crew visit schedule module allows for expedient solving to minimize waiting times for workers. The optimization may be efficiently solved using, for example, a mixed-integer linear programming (MILP) solver, such as IBM ILOG CPLEX Optimization Studio, commonly referred to as “CPLEX.”

In one example of solving the optimization of the algorithm, a comparison of run time with CPLEX was carried out on real-world data. As can be seen in Table 1, the proposed algorithm results are considerably less than the CPLEX results:

TABLE 1
Test Instance Characteristics and Running Times

| Case | | # Digging | # | Proposed | CPLEX |
|---|---|---|---|---|---|
| No. | Date | Events | Workers | (sec) | (sec) |
| 1 | 06/11/YR | 1237 | 33 | 113.51 | 176.18 |
| 2 | 06/12/YR | 528 | 20 | 4.52 | 7.41 |
| 3 | 06/13/YR | 610 | 20 | 14.06 | 13.79 |
| 4 | 06/14/YR | 598 | 20 | 6.24 | 9.85 |
| 5 | 06/15/YR | 605 | 20 | 10.47 | 13.52 |
| 6 | 06/16/YR | 81 | 8 | 0.03 | 0.06 |
| 7 | 06/18/YR | 1218 | 33 | 124.85 | 160.17 |

# Digging events: number of registered digging events
# Workers: number of available inspectors

Additionally, a crew visit schedule can be derived, as shown in Table 2:

TABLE 2
Scheduled Crew Visit for 6/15/YR

| | Outage | Depot | Crew |
|---|---|---|---|
| Digging ID | Probability | Number | Number |
| E1206150346 | 0.023076 | — | — |
| E1206150087 | 0.018043 | 2 | 3 |
| E1206150465 | 0.019641 | 1 | 4 |
| E1206150508 | 0.000272 | — | — |
| E1206150277 | 0.083793 | 4 | 1 |
| E1206150304 | 0.005796 | 3 | 3 |
| E1206150117 | 0.004873 | 1 | 5 |

Outage Probability: estimated outage probability
Depot Number: ID of the depot
Crew Number: ID of the supervisor

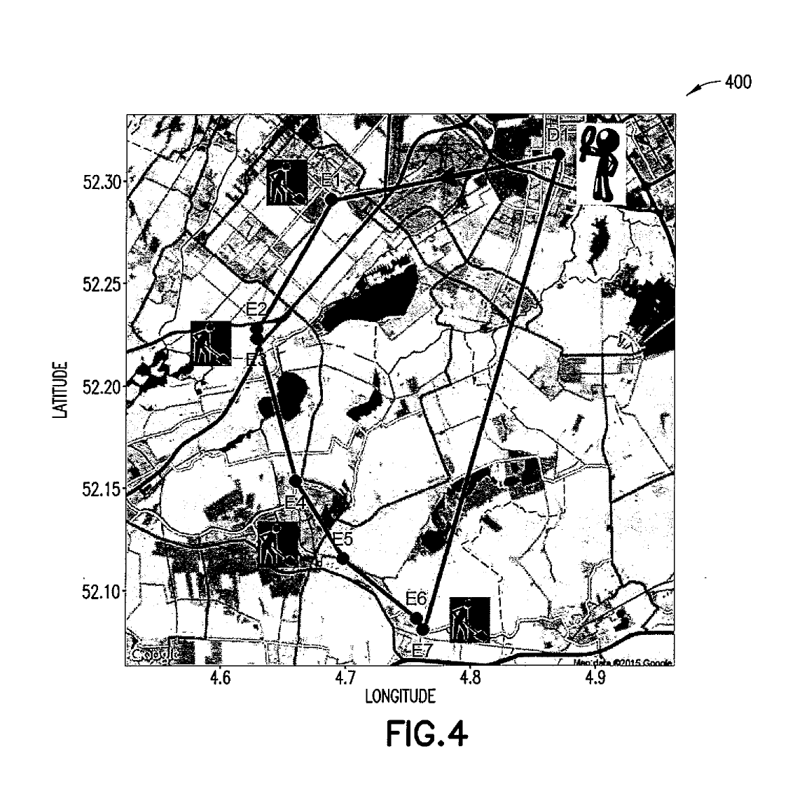

Referring now to FIG. 4, a conceptual depiction of illustrative results generated by the crew schedule optimizer 200 is shown generally at 400. In the conceptual depiction 400, a supervisor starting at depot D1 is tasked with traveling to and supervising work for a specified period of time successively at each of work sites E1 through E7, followed by a return to the depot D1.

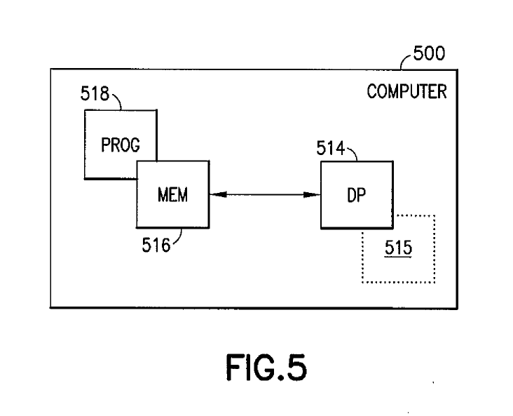

Referring now to FIG. 5, a simplified block diagram of various electronic devices and apparatuses that are suitable for use in practicing the exemplary embodiments described herein is shown. For example, a computer 500 may be used to control one or more of the processes as described above. The computer 500 includes a controller, such as a computer or a data processor (DP) 514 and a computer-readable memory medium embodied as a memory (MEM) 516 that stores a program of computer instructions (PROG) 518.

The FROG 518 includes program instructions that, when executed by the associated DP 514, enable the various electronic devices and apparatuses to operate in accordance with exemplary embodiments. That is, various exemplary embodiments may- be implemented at least in part by computer software executable by the DP 514 of the computer 510, or by hardware, or by a combination of software and hardware (and firmware).

The computer 510 may also include dedicated processors, for example a processor 515 that controls the data processing and optimization processes.

The computer readable MEM 516 may be of any type suitable to the local technical environment and may be implemented using any suitable data storage technology, such as semiconductor based memory devices, flash memory, magnetic memory devices and systems, optical memory devices and systems, fixed memory, and removable memory. The DP 514 may be of any type suitable to the local technical environment, and may include one or more of general purpose computers, special purpose computers, microprocessors, digital signal processors (DSPs), and processors based on a multicore processor architecture, as non-limiting examples.

The exemplary embodiments, as discussed herein and as particularly described with respect to exemplary methods, may be implemented in conjunction with a program storage device (e.g., at least one memory) readable by a machine, tangibly embodying a program of instructions (e.g., a program or computer program) executable by the machine for performing operations. The operations comprise utilizing the exemplary embodiments of the methods described herein.

In one exemplary aspect, a method comprises obtaining, at a data correction module, at least one input indicative of a planned digging activity, the planned digging activity occurring within a prescribed period of time, the at least one input comprising information relating to the planned digging activity; generating, using the data correction module, a correction of the input of the planned digging activity; generating, using a predictive modeling module, an outage probability of a utility as a function of the corrected input of the planned digging activity event and predictive data based on a predictive modeling technique; generating, using a scheduling optimization algorithm, an optimal schedule as a function of a travel cost and the outage probability of the utility; and initiating a response based on the optimal schedule to mitigate an occurrence of a power outage predicted to result from the planned digging activity.

Generating a correction of the input may comprise correcting an aspect of the planned digging activity using a combined clustering, association, and statistical modeling method. Generating an outage probability of the utility as a function of the corrected input of the planned digging activity event and predictive data based on a predictive modeling technique may comprise using a set of trained models and parameter priors to predict a risk based on at least one aspect indicative of risk. Generating an optimal schedule as a function of the outage probability may comprise operating on vector-based data indicative of biographical, geographical, and historical characteristics of entities associated with the utility, data indicative of the outage probability of the utility, and the travel cost may comprise operational constraint information. The method may further comprise selecting a schedule for a human digging supervisor to visit at least one job site. The travel cost may comprise at least one of an accounting of a number of available supervisors, travel distances, start/end times of jobs, times of travel and/or service, whether or not travel is between multiple depots, coordination of schedules between depots, maintenance of scheduled services, and whether or not partial visits to jobsites are desired. The scheduling optimization algorithm may be:

$${min}_{{x}_{i , j}^{n} ∈ \{ 0 , 1 \}} {\sum }_{( i , j ) ∈ 𝒜 , n ∈ 𝒟} {c}_{i , j} {x}_{i , j}^{n} + β {\sum }_{j ∈ 𝒯} ( {\sum }_{i ∈ {𝒩}_{j} , n ∈ 𝒟} {x}_{i , j}^{n} {q}_{j} {c}_{j}^{out} + ( 1 - {\sum }_{i ∈ {𝒩}_{j} , n ∈ 𝒟} {x}_{i , j}^{n} ) {p}_{j} {c}_{j}^{out} )$$

where x_{i,j}ⁿ=1 if any worker at depot n is traveling along arc (i, j); [symbol] is the set of arcs in a graph; [symbol] is the set of depots; c_{i,j} is the cost for traveling along arc (i, j); β is a coefficient to be estimated; [symbol] is the scheduling time horizon; N is the set of nodes in an undirected graph; qⱼ is the outage probability for a digging event is the event is not visited; cᵢ^{out} is the outage cost for digging event i; and pⱼ is the outage probability for a digging event is the event is not visited.

In another exemplary aspect, a method for reducing an occurrence of power outage caused by a planned digging activity comprises receiving, at a data correction module, a first set of data relating to a notification indicative of a digging activity; updating the received first set of data to include a second set of data relating to the notification indicative of a digging activity; predicting a risk factor, based on the updated first set of data and the included second set of data, using a set of trained models and parameter priors to define a risk ranking; optimizing a schedule for a human supervisor to visit the digging activity, the optimized schedule being a function of a travel cost and the risk ranking; and using the schedule to cause the human supervisor to visit the digging activity based on the optimized schedule, the response being a function of the risk ranking.

Updating the received first set of data may comprise implementing a combination of clustering, association, and statistical modeling methods to incorporate the second set of data relating to the notification indicative of a digging activity with the first set of data. Implementing a combination of clustering, association, and statistical modeling methods may comprise clustering digging events as a function of information pertaining to a cost of a proposed outage caused by the digging activity and at least one labor constraint relating to a repair of the digging activity. Predicting a risk factor may comprise using an algorithm capable of expressing a dependent variable as a linear combination of at least one of the first set of data and the first set of data with the second set of data included. The algorithm used to express the dependent variable may comprise at least one of a logistic regression model, a Bayesian logistic regression model, and a linear discriminant analysis model. Optimizing a schedule may comprise generating a visit schedule for a human supervisor as a function of travel cost and a cost of a proposed outage caused by the digging activity. Generating a visit schedule may comprise an accounting of a number of available supervisors, travel distances, start/end times of jobs, times of travel and/or service, whether or not travel is between multiple depots, coordination of schedules between depots, maintenance of scheduled services, and whether or not partial visits to jobsites are desired. Optimizing a schedule for a human supervisor to visit the digging activity may be carried out using:

$${min}_{{x}_{i , j}^{n} ∈ \{ 0 , 1 \}} {\sum }_{( i , j ) ∈ 𝒜 , n ∈ 𝒟} {c}_{i , j} {x}_{i , j}^{n} + β {\sum }_{j ∈ 𝒯} ( {\sum }_{i ∈ {𝒩}_{j} , n ∈ 𝒟} {x}_{i , j}^{n} {q}_{j} {c}_{j}^{out} + ( 1 - {\sum }_{i ∈ {𝒩}_{j} , n ∈ 𝒟} {x}_{i , j}^{n} ) {p}_{j} {c}_{j}^{out} )$$

where x_{i,j}ⁿ=1 if any worker at depot n is traveling along arc (i, j); [symbol] is the set of arcs in a graph; [symbol] is the set of depots; c_{i,j} is the cost for traveling along arc (i, j); β is a coefficient to be estimated; [symbol] is the scheduling time horizon; N is the set of nodes in an undirected graph; qⱼ is the outage probability for a digging event is the event is not visited; cᵢ^{out} is the outage cost for digging event i; and pⱼ is the outage probability for a digging event is the event is not visited.

In another exemplary aspect, a computer program product for reducing an occurrence of power outage caused by a planned digging activity comprises a computer readable storage medium having program instructions embodied therewith, the program instructions being executable by a computer to cause the computer to: receive, at a data correction module, a first set of data relating to a notification indicative of a digging activity; update the received first set of data to include a second set of data relating to the notification indicative of a digging activity; predict a risk factor, based on the updated first set of data and the included second set of data, using a set of trained models and parameter priors to define a risk ranking; and optimize a schedule for a human supervisor to visit the digging activity, the optimized schedule being a function of a travel cost and the risk ranking.

Updating the received first set of data may comprise causing the computer to implement a combination of clustering, association, and statistical modeling methods to incorporate the second set of data relating to the notification indicative of a digging activity with the first set of data. Causing the computer to implement a combination of clustering, association, and statistical modeling methods may comprise clustering digging events as a function of information pertaining to a cost of a proposed outage caused by the digging activity and at least one labor constraint relating to a repair of the digging activity. Predicting a risk factor may comprise using an algorithm capable of expressing a dependent variable as a linear combination of at least one of the first set of data and the first set of data with the second set of data included. The algorithm used to express the dependent variable may comprise at least one of a logistic regression model, a Bayesian logistic regression model, and a linear discriminant analysis model.

The foregoing description has provided by way of exemplary and non-limiting examples a full and informative description of the best method and apparatus presently contemplated by the inventors for carrying out various exemplary embodiments. However, various modifications and adaptations may become apparent to those skilled in the relevant arts in view of the foregoing description, when read in conjunction with the accompanying drawings and the appended claims. However, all such and similar modifications will still fall within the scope of the teachings of the exemplary embodiments.

Furthermore, some of the features of the preferred embodiments could be used to advantage without the corresponding use of other features. As such, the foregoing description should be considered as merely illustrative of the principles, and not in limitation thereof.

What is claimed is:

1. A method, comprising:
obtaining, at a data correction module, at least one input indicative of a planned digging activity, the planned digging activity occurring within a prescribed period of time, the at least one input comprising information relating to the planned digging activity;
generating, using the data correction module, a correction of the input of the planned digging activity;
generating, using a predictive modeling module, an outage probability of a utility as a function of the corrected input of the planned digging activity event and predictive data based on a predictive modeling technique;
generating, using a scheduling optimization algorithm, an optimal schedule as a function of a travel cost and the outage probability of the utility; and
initiating a response based on the optimal schedule to mitigate an occurrence of a power outage predicted to result from the planned digging activity.

2. The method of claim 1, wherein generating a correction of the input comprises correcting an aspect of the planned digging activity using a combined clustering, association, and statistical modeling method.

3. The method of claim 1, wherein generating an outage probability of the utility as a function of the corrected input of the planned digging activity event and predictive data based on a predictive modeling technique comprises using a set of trained models and parameter priors to predict a risk based on at least one aspect indicative of risk.

4. The method of claim 1, wherein generating an optimal schedule as a function of the outage probability comprises operating on vector-based data indicative of biographical, geographical, and historical characteristics of entities associated with the utility, data indicative of the outage probability of the utility, and wherein the travel cost comprises operational constraint information.

5. The method of claim 4, further comprising selecting a schedule for a human digging supervisor to visit at least one job site.

6. The method of claim 1, wherein the travel cost comprises at least one of an accounting of a number of available supervisors, travel distances, start/end times of jobs, times of travel and/or service, whether or not travel is between multiple depots, coordination of schedules between depots, maintenance of scheduled services, and whether or not partial visits to jobsites are desired.

7. The method of claim 1, wherein the scheduling optimization algorithm is:
$${min}_{{x}_{i , j}^{n} ∈ \{ 0 , 1 \}} {\sum }_{( i , j ) ∈ 𝒜 , n ∈ 𝒟} {c}_{i , j} {x}_{i , j}^{n} + β {\sum }_{j ∈ 𝒯} ( {\sum }_{i ∈ {𝒩}_{j} , n ∈ 𝒟} {x}_{i , j}^{n} {q}_{j} {c}_{j}^{out} + ( 1 - {\sum }_{i ∈ {𝒩}_{j} , n ∈ 𝒟} {x}_{i , j}^{n} ) {p}_{j} {c}_{j}^{out} )$$
where x_{i,j}ⁿ=1 if any worker at depot n is traveling along arc (i, j); [symbol] is the set of arcs in a graph; [symbol] is the set of depots; c_{i,j} is the cost for traveling along arc (i, j); β is a coefficient to be estimated; [symbol] is the scheduling time horizon; N is the set of nodes in an undirected graph; qⱼ is the outage probability for a digging event is the event is not visited; cᵢ^{out} is the outage cost for digging event i; and pⱼ is the outage probability for a digging event is the event is not visited.

8. A method for reducing an occurrence of power outage caused by a planned digging activity, the method comprising:
receiving, at a data correction module, a first set of data relating to a notification indicative of a digging activity;
updating the received first set of data to include a second set of data relating to the notification indicative of a digging activity;
predicting a risk factor, based on the updated first set of data and the included second set of data, using a set of trained models and parameter priors to define a risk ranking;
optimizing a schedule for a human supervisor to visit the digging activity, the optimized schedule being a function of a travel cost and the risk ranking; and
using the schedule to cause the human supervisor to visit the digging activity based on the optimized schedule, the response being a function of the risk ranking.

9. The method of claim 8, wherein updating the received first set of data comprises implementing a combination of clustering, association, and statistical modeling methods to incorporate the second set of data relating to the notification indicative of a digging activity with the first set of data.

10. The method of claim 9, wherein implementing a combination of clustering, association, and statistical modeling methods comprises clustering digging events as a function of information pertaining to a cost of a proposed outage caused by the digging activity and at least one labor constraint relating to a repair of the digging activity.

11. The method of claim 8, wherein predicting a risk factor comprises using an algorithm capable of expressing a dependent variable as a linear combination of at least one of the first set of data and the first set of data with the second set of data included.

12. The method of claim 11, wherein the algorithm used to express the dependent variable comprises at least one of a logistic regression model, a Bayesian logistic regression model, and a linear discriminant analysis model.

13. The method of claim 8, wherein optimizing a schedule comprises generating a visit schedule for a human supervisor as a function of travel cost and a cost of a proposed outage caused by the digging activity.

14. The method of claim 13, wherein generating a visit schedule comprises accounting of a number of available supervisors, travel distances, start/end times of jobs, times of travel and/or service, whether or not travel is between multiple depots, coordination of schedules between depots, maintenance of scheduled services, and whether or not partial visits to jobsites are desired.

15. The method of claim 8, wherein optimizing a schedule for a human supervisor to visit the digging activity is carried out using:
$${min}_{{x}_{i , j}^{n} ∈ \{ 0 , 1 \}} {\sum }_{( i , j ) ∈ 𝒜 , n ∈ 𝒟} {c}_{i , j} {x}_{i , j}^{n} + β {\sum }_{j ∈ 𝒯} ( {\sum }_{i ∈ {𝒩}_{j} , n ∈ 𝒟} {x}_{i , j}^{n} {q}_{j} {c}_{j}^{out} + ( 1 - {\sum }_{i ∈ {𝒩}_{j} , n ∈ 𝒟} {x}_{i , j}^{n} ) {p}_{j} {c}_{j}^{out} )$$
x_{i,j}ⁿ=1 if any worker at depot n is traveling along arc (i, j); [symbol] is the set of arcs in a graph; [symbol] is the set of depots; c_{i,j} is the cost for traveling along arc (i, j); β is a coefficient to be estimated; [symbol] is the scheduling time horizon; N is the set of nodes in an undirected graph; qⱼ is the outage probability for a digging event is the event is not visited; cᵢ^{out} is the outage cost for digging event i; and pⱼ is the outage probability for a digging event is the event is not visited.

16. A computer program product for reducing an occurrence of power outage caused by a planned digging activity, the computer program product comprising a computer readable storage medium having program instructions embodied therewith, the program instructions being executable by a computer to cause the computer to:
receive, at a data correction module, a first set of data relating to a notification indicative of a digging activity;
update the received first set of data to include a second set of data relating to the notification indicative of a digging activity;
predict a risk factor, based on the updated first set of data and the included second set of data, using a set of trained models and parameter priors to define a risk ranking; and
optimize a schedule for a human supervisor to visit the digging activity, the optimized schedule being a function of a travel cost and the risk ranking.

17. The apparatus of claim 16, wherein updating the received first set of data comprises causing the computer to implement a combination of clustering, association, and statistical modeling methods to incorporate the second set of data relating to the notification indicative of a digging activity with the first set of data.

18. The apparatus of claim 17, wherein causing the computer to implement a combination of clustering, association, and statistical modeling methods comprises clustering digging events as a function of information pertaining to a cost of a proposed outage caused by the digging activity and at least one labor constraint relating to a repair of the digging activity.

19. The apparatus of claim 16, wherein predicting a risk factor comprises using an algorithm capable of expressing a dependent variable as a linear combination of at least one of the first set of data and the first set of data with the second set of data included.

20. The apparatus of claim 19, wherein the algorithm used to express the dependent variable comprises at least one of a logistic regression model, a Bayesian logistic regression model, and a linear discriminant analysis model.
